(19) United States
(12) Patent Application Publication
(10) Pub. No.: US 2007/0280156 A1
(43) Pub. Date: Dec. 6, 2007

(54) Data structure, data slot allocation method for transmission of uncompressed AV data and transmission method thereof, and apparatus using the same

(75) Inventors: Chang-yeul Kwon, Yongin-si (KR); Chil-youl Yang, Gwanak-gu (KR); Se-young Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/714,120

(22) Filed: Mar. 6, 2007

(30) Foreign Application Priority Data
Jun. 5, 2006 (KR) 10-2006-0050518

(51) Int. Cl. H04Q 7/00

(52) U.S. Cl. 370/328

(57) ABSTRACT

Provided are an apparatus and method for allocating a data slot to transmit uncompressed audiovisual (AV) data. The method includes transmitting a first superframe that includes a data-slot-reservation period during a first beacon period and information thereon; receiving a frame that requests the data slot from at least one of wireless devices included in a network, in the data-slot-request period; transmitting a response frame to the data-slot-request frame to at least one of the wireless devices; and transmitting a second superframe that includes a data slot allocated to at least one of the wireless devices during a second beacon period.

### CROSS-REFERENCE TO RELATED APPLICATION

This application is based on, and claims priority from Korean Patent Application No. 10-2006-0050518 filed on Jun. 5, 2006, in the Korean Intellectual Property Office, the disclosure of which is incorporated herein in its entirety by reference.

### BACKGROUND OF THE INVENTION

1. Field of the Invention

The present invention relates to a wireless telecommunications technology, and more particularly, to a method and apparatus for providing transmission efficiency and stability when wirelessly transmitting mass data.

2. Description of the Related Art

In line with the increase in wireless network use and demand for mass data transmission, research on an efficient transmission method is required. Due to the nature of the wireless network where wireless resources are shared among a plurality of devices, if competition increases, it is likely that data will be lost, thereby wasting the wireless resources due to data collisions encountered during transmission. In order to reduce the collisions and loss, and stably transmit and receive data, a competition-based distributed coordination function (DCF) or a non-competitive point coordination function (PCF) are used in a wireless local area network (LAN), and a time-dividing method called channel time allocation is used in a wireless personal area network (PAN).

Although the application of the above-mentioned methods to the wireless network somewhat reduces the collision and ensures stable transmission, it is still likely that a data collision will occur during transmission. That is, since there are many events that interfere with stable transmission by nature such as multiple paths, fading, and interference. In addition, as the number of the devices in the wireless network increases, it is more likely that data collisions and loss will occur.

The collision results in retransmission which has a negative influence on throughput. Specifically, in order to provide quality of service (QoS), it is crucial to minimize the number of retransmissions and have as much available bandwidth as possible.

Moreover, considering there is great demand in wireless transmission of high quality video images such as digital video disk (DVD) and high definition television (HDTV) images, it is necessary to establish a technical standard for continuous transmission of the high quality video images requiring broad bandwidth without interruption.

Currently, an IEEE 802.15.3c task group is working to establish the technical standard for the transmission of mass data in a wireless home network. This standard is called Millimeter (mm) Wave, and it uses a radio having a wavelength in the millimeter range, i.e., a frequency in the range of 30 GHz to 300 GHz, in order to transmit large quantities of data. Conventionally, such a frequency range is unlicensed, and its use has been limited to telecommunication services, radio astronomy, and the prevention of automotive collisions.

FIG. 1 is a drawing comparing a frequency band of IEEE 802.11 standards with that of the mmWave frequency band. IEEE 802.11b and IEEE 802.11g use a 2.4 GHz frequency band, and have a 20 MHz bandwidth. In addition, IEEE 802.11a and IEEE 802.11n use a 5 GHz frequency band, and have a 20 MHz bandwidth. Conversely, mmWave uses 60 GHz, and has bandwidth in the range of 0.5 to 2.5 GHz. As such, mmWave uses a higher frequency band and has a larger bandwidth.

As mentioned above, data can be transmitted at a high rate (e.g. Gbps) using the mmWave frequency band, and the size of an antenna can be set to 1.5 mm or less, thereby allowing the antenna to be included in a single chip. In addition, the use of high frequency signals is advantageous in that interference among the devices can be reduced due to a high attenuation ratio in the air.

However, problems lie in that such high attenuation ratio results in a short physical reach, and high linearity of the signals prevents a smooth transmittal in a non-line-of-sight environment. Therefore, an array antenna is used and beam steering is applied in order to resolve the issues.

Recently, in addition to a technique for transmitting compressed data using bandwidth in tens of GHz in a home or an office, a method of transmitting uncompressed data using mmWave in a high-frequency band has been introduced. The word “uncompressed” means not compressed in the aspect of loss encoding and non-loss encoding (can be completely restored).

Uncompressed AV data is uncompressed mass data, and thus is transmittable only in the high frequency band (e.g. in tens of GHz). Despite packet loss, the display of the data is not greatly affected. Accordingly, Automatic Repeat Request (ARQ) or Retry may not be executed. In order to efficiently transmit the uncompressed AV data in the high frequency band having the characteristics mentioned above, an efficient media-access method is needed.

### SUMMARY OF THE INVENTION

In view of the above, it is an object of the present invention to provide a method and apparatus for efficiently transmitting uncompressed AV data via mmWave.

The aspects of the present invention will become clear to those skilled in the art upon review of the following description, attached drawings and appended claims.

According to an aspect of the present invention, there is provided a method of allocating a data slot to transmit uncompressed AV data, the method including transmitting a first superframe that includes a data-slot-reservation period during a first beacon period and information thereon, receiving a frame that requests the data slot from at least one of wireless devices included in a network in the data-slot-request period, transmitting a response frame to the data-slot-request frame to at least one of the wireless devices, and transmitting a second superframe that includes a data slot allocated to at least one of the wireless devices during a second beacon period.

According to another aspect of the present invention, there is provided a method of transmitting uncompressed AV data, the method including receiving a first superframe that includes a data-slot-reservation period and information thereon from a network coordinator during a first beacon period, transmitting a frame in the data-slot-reservation period, which requests a data slot from the network coordinator, receiving a superframe that includes the data slot allocated from the network coordinator during a second beacon period, and transmitting uncompressed AV data in the allocated data slot period to other devices.

According to still another aspect of the present invention, there is provided an apparatus for allocating a data slot for uncompressed AV data, the apparatus including a unit that transmits a first superframe that includes a data-slot-reservation period during a first beacon period and information thereon, a unit that receives a frame that request the data slot from at least one of the wireless devices included in a network in the data-slot-request period, a unit that that transmits frame to the data-slot-request frame to at least one of the wireless devices, and a unit that transmits a second superframe that includes a data slot allocated to at least one of the wireless devices during a second beacon period.

According to yet another aspect of the present invention, there is provided an apparatus for transmitting uncompressed AV data, the apparatus including a unit that receives a first superframe that includes a data-slot-reservation period and information thereon from a network coordinator during a first beacon period, a unit that transmits a frame in the data-slot-reservation period, which requests a data slot from the network coordinator, a unit that receives a superframe that includes the data slot allocated by the network coordinator during a second beacon period, and a unit that transmits uncompressed AV data in the allocated data slot period to other devices.

### BRIEF DESCRIPTION OF THE DRAWINGS

The above and other features and advantages of the present invention will become apparent by describing in detail exemplary embodiments thereof with reference to the attached drawings, in which:

FIG. 1 is a drawing comparing the frequency band of IEEE 802.11 standards with the mmWave frequency band;

FIG. 2 illustrates a time-dividing method according to IEEE 802.15.3;

FIG. 3 is a drawing briefly illustrating an environment to which the present invention is applied;

FIG. 4 is a drawing illustrating a configuration of an association-request frame according to an exemplary embodiment of the present invention;

FIG. 5 is a drawing illustrating a configuration of an association-response frame according to an exemplary embodiment of the present invention;

FIG. 6 is a drawing illustrating a configuration of a data-slot-request frame according to an exemplary embodiment of the present invention;

FIG. 7 is a drawing illustrating a configuration of a data-slot-response frame according to an exemplary embodiment of the present invention;

FIG. 8 illustrates a configuration of a superframe according to a first exemplary embodiment of the present invention;

FIG. 9 illustrates a configuration of an Information Element containing information on a “BWP” period according to an exemplary embodiment of the present invention;

FIGS. 10 and 11 illustrate a configuration of superframes according to information set by the Information Element of FIG. 9;

FIG. 12 illustrates a configuration of a superframe according to a second exemplary embodiment of the present invention;

FIGS. 13 and 14 illustrate a configuration of a superframe in accordance with information set by the Information Element of FIG. 9 according to the second exemplary embodiment of the present invention;

FIG. 15 illustrates a configuration of a superframe according to a third exemplary embodiment of the present invention;

FIGS. 16 and 17 illustrate a configuration of a superframe according to a third exemplary embodiment of the present invention, wherein the superframe is in relation to information set by the Information Element of FIG. 9;

FIG. 18 is a block diagram illustrating a configuration of a network coordinator according to an exemplary embodiment of the present invention; and

FIG. 19 illustrates a configuration of a wireless device according to an exemplary embodiment of the present invention.

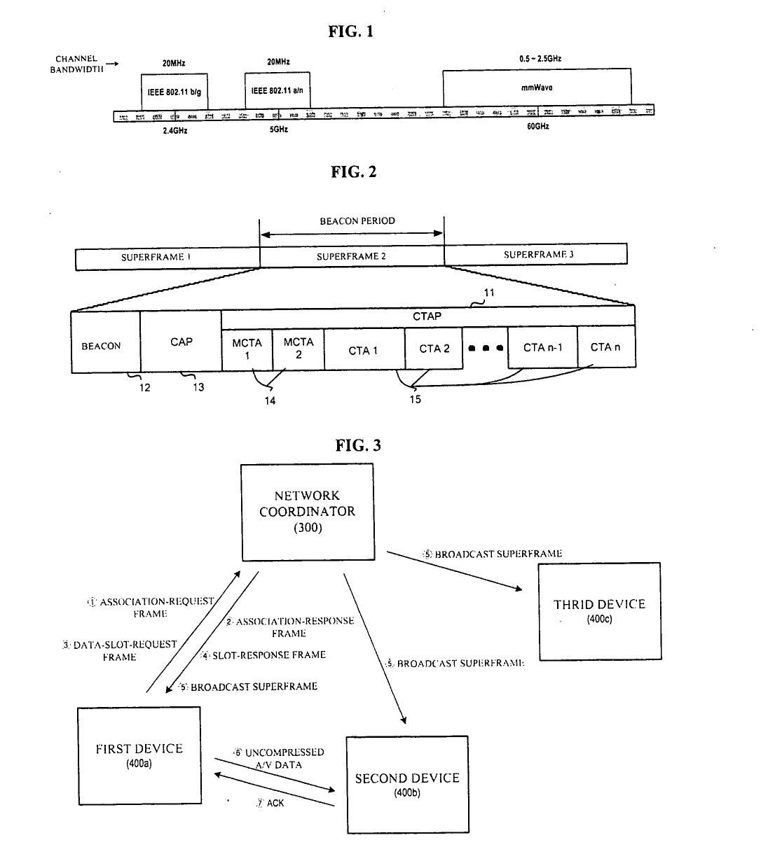

### DETAILED DESCRIPTION OF THE INVENTION

Exemplary embodiments of the present invention will be described in detail with reference to the accompanying drawings.

Aspects of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Exemplary embodiments of the present invention are described hereinafter with reference to flowchart illustrations of user interfaces, methods, and computer program products according to exemplary embodiments of the invention.

It will be understood that each block of the flowchart illustrations, and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute in the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order depending upon the functionality involved.

FIG. 2 illustrates a time-dividing method according to IEEE 802.15.3. IEEE 802.15.3 MAC establishes wireless network connections quickly, and is a piconet in ad hoc fashion, as opposed to a wireless network with an access point (AP). Referring to FIG. 2, temporal periods for transmitting and receiving of data among devices are arranged in a temporal arrangement structure called a superframe. The super frame includes beacon 12 that contains control information, a contention access period (CAP) 13 that transmits data via a backoff, and a channel time allocation period (CTAP) 11 that transmits the data at an allocated time without competition. Here, a competitive access method is used in the CAP 13 and a management channel time allocation (MCTA) 14. Specifically, carrier sense multiple access/collision avoidance (CSMA/CA) is used in the CAP 13 and slotted aloha is used in the MCTA 14.

In addition to the MCTA 14, the CTAP 11 is formed of a plurality of channel time allocations (CTAs) 15. The CTA 15 is classified into a dynamic CTA and a pseudostatic CTA. The dynamic CTA may be differently situated in each superframe, and cannot be used in the superframe if it lost the beacon. The pseudostatic CTA, on the other hand, is invariably situated in each superframe, and the CTA period may be used in a fixed position even if the pseudostatic CTA lost the beacon. However, if more than “mMaxLostBeacons” are lost, the CTA period cannot be used.

As mentioned above, IEEE 802.15.3 MAC is formed based on time division multiple access (TDMA) that guarantees stable QoS, and is optimum particularly for multimedia A/V streaming in a home network. However, IEEE 802.15.3 MAC needs to be improved in order to transmit AV data in a high frequency band in tens of GHz.

In general, the MAC frame transmitted and received among network devices includes a data frame and a control frame.

The control frame, which refers to all other frames except for the data frame, assists in the transmission of the data frame. For example, the control frame includes an association-request frame that requests participation in the network established by a network coordinator, a data slot request frame that requests a data slot frame to transmit isochronous data, a probe request frame that request a network search, a coordinator handover request frame that hands over its responsibility, and a response frame that responds to the aforementioned frames. In addition, the control frame includes an acknowledgement frame (ACK) that acknowledges receipt of a frame.

There is no significant difference between the size of the data frame and that of the control frame in IEEE 802.15.3. The data frame can be up to 2048 bytes and a command frame can be up to tens or hundreds of bytes. However, the data frame is enlarged in order to transmit the uncompressed AV data in the tens of GHz frequency band, while the command frame does not. Accordingly, the use of the conventional IEEE 802.15.3 is ineffective.

In the CAP 13 and the MCTA 14 of the conventional IEEE 802.15.3, each control frame and asynchronous data frame competitively access the channel. In this case, as the asynchronous data frame with relatively low importance has more chances of acquiring the channel than the control frame, the control frame necessary for the transmission of uncompressed isochronous data has less chance of being transmitted. In addition, the control frame with respect to data slot allocation and the frame required for the device to participate in the network have relatively higher importance than other control frames, however, they are in contention in the same period, thereby not being able to stably acquire the channel. If the device fails to transmit and receive such important control data, it will also lose an opportunity to transmit a mass of the uncompressed AV data. Accordingly, network throughput may drastically decrease.

Therefore, a time period required to transmit the relatively important control frame should be arranged in the superframe, and is deemed to be a contention period because a plurality of devices included in the network are in contention.

FIG. 3 is a drawing briefly illustrating an environment to which exemplary embodiments of the present invention are applied. A network coordinator 300 and at least one of devices 400a, 400b, and 400c establish a network. The network coordinator 300 regularly broadcasts a superframe during a beacon period. Therefore, the devices 400a, 400b, and 400c may transmit a control frame, a data frame, and an ACK in a contention period or in a non-contention period included in the superframe.

If the first device 400a that is not initially engaged in a network wishes to participate in the network, it needs to transmit an association-request frame to the network coordinator 300 competing with the second and third devices 400b and 400c during the contention period of the superframe (\textcircled{1} in FIG. 3), and receive an association-response frame (\textcircled{2} in FIG. 3).

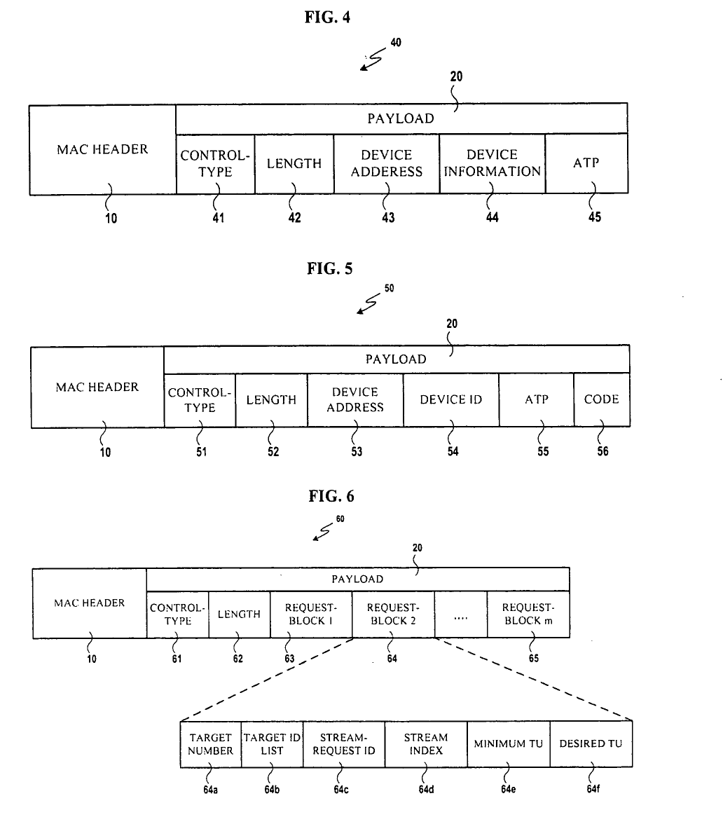

FIG. 4 illustrates a configuration of an association-request frame 40 according to an exemplary embodiment of the present invention. An association-request frame 40 is formed of a MAC header 10 and a payload 20. The payload 20 may be formed of a control-type field 41, a length field 42, a device address field 43, a device-information field 44, and an association-timeout-period (ATP) field 45.

The control type field 41 displays a corresponding control frame, i.e., an identifier that identifies the association-request frame 40 and the length frame 42 records a sum of the following fields 43, 44, and 45 in bytes.

The device address field 43 records a hardware address of the first device 400a (e.g. a MAC address up to 8 bytes) that transmits the association-request frame 40. In addition, the device information field 44 records a variety of device information of the first device 400a such as a function, a performance, and a capacity. The ATP 45 displays a maximum time where the network coordinator 300 and the first device 400a sustain the association without communicating with each other. There is no communication therebetween for the maximum period of time when the network coordinator 300 is unassociated from the first device 400a.

As a response to the association-request frame 40, the network coordinator 300 transmits an association-response frame 50 to the first device 400a. FIG. 5 illustrates a configuration of an association-response frame 50 according to an exemplary embodiment of the present invention. The association-response frame 50 may be formed of a payload 20, a control-type field 51, a length field 52, a device-address field 53, a device-ID field 54, an ATP field 55, and a code field 56.

The control type field 51 displays an identifier that identifies the association-response frame 50 and the length field 52 records the sum of the subsequent fields 53, 54, 55, and 56 in bytes, and the device address field 53 records a hardware address of a first device.

The device ID field 54 records an ID that identifies the device in a network, and thus, may be much smaller (e.g. 1 byte) than the hardware address (e.g. 8 bytes). Accordingly, the device ID can reduce overhead when communication is established among the devices.

The ATP field 55 records a final time out determined by the network coordinator 400a. The final time may be different if the network coordinator 400a cannot support the request time in the ATP field 45 of FIG. 4.

The code field 56 displays a value for an approval or a rejection. For example, 0 denotes approval, and 1 through 8 denote reasons for rejections. The reasons include an excess of associable devices, a lack of allocatable time slots, and a poor channel condition.

Not until the first device 400a receives an approval for the association-request from the association-response frame 50, is it engaged in the network. The first device 400a should ask the network coordinator 300 for a data slot (\textcircled{3} in FIG. 3) in order to transmit uncompressed AV data to a second device 400b.

A request for the data slot can be made via a data-slot-request frame 60 of FIG. 6. A payload 20 of the data-slot-request frame 60 includes a control-type field 61, a length field 62, and at least one of request-block fields 63, 64, and 65.

The request-block field 64 may be formed of a target-number field 64a that denotes the number of receivers, a target-ID-list field 64b that lists IDs of the receivers, a stream-request-ID field 64c that identifies the version of the data-slot-request frame 60, a stream-index field 64d that is required to identify the data, a minimum time unit (TU) field 64e that denotes a minimum size required for the data slot, and a desired TU field 64f that denotes a desired size of the data slot.

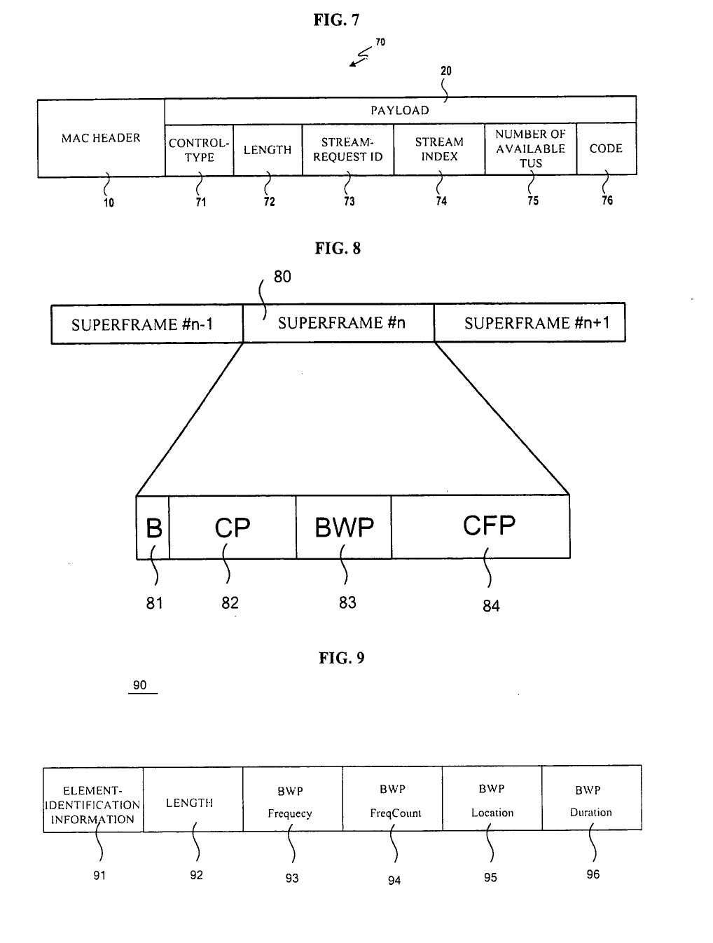

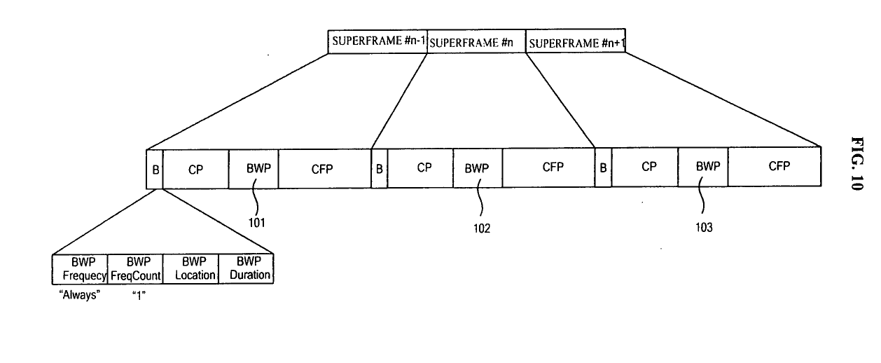

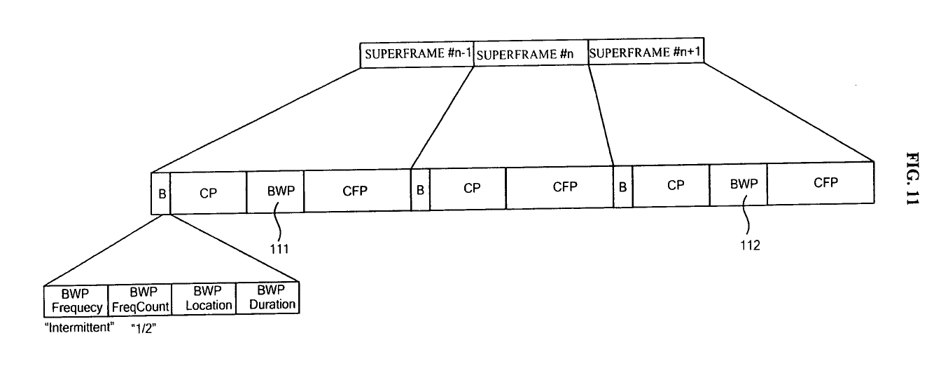

If the first device 400a transmits the data-slot-request frame 40 to the network coordinator 300 through contention with the second and third devices 400b and 400c during a contention period (\textcircled{3} in FIG. 3), the network coordinator 300 transmits a data-slot-request frame 70 of FIG. 7 to the first device 400a (\textcircled{4} in FIG. 3).

A payload 20 of the data-slot-response frame 70 may be formed of a control-type field 71, a length field 72, a stream-request-ID field 73, a stream-index field 74, an available-TU-number field 75, and a code field 76.

Fields 71, 72, 73, and 74 record the same contents as the data-slot-request frame 60. In addition, the available-TU-number field 75 records the number of TU per data slot that is finally allocated by the network coordinator 300. Then the code field 76 displays a value for an approval for or a rejection of the data slot request.

The network coordinator 300 transmits the data-slot-response frame 70, and broadcasts a superframe including the data slots allocated to the first, second and third devices 400a, 400b, and 400c during the beacon period (\textcircled{5} of FIG. 3).

If the first device 400a receives a data slot from the network coordinator 300 by the broadcasted superframe, the first device 400a can transmit uncompressed AV data to the second device (\textcircled{6} of FIG. 3). With respect to the uncompressed AV data transmission, the second device 400b may transmit an ACK frame to the first device 400a (\textcircled{7} of FIG. 3). However, no ACK policy may be used since even slight errors occurring on account of the nature of the uncompressed AV data do not greatly affect the image being played. Even in the case of the transmission of the ACK frame, the ACK frame according to an exemplary embodiment of the present invention may not be transmitted via the data slot. The data slot should be transmitted for a smooth transmission of the uncompressed AV data and the ACK like all other control frames should be transmitted during the contention period through contention.

FIGS. 8 through 17 are drawings illustrating a configuration of a superframe according to a variety of exemplary embodiments of the present invention. The superframe is further divided into a beacon-transmission period, a contention period, and a non-contention period.

The contention period according to the exemplary embodiments of the present invention is different from the contention period according to the conventional IEEE 802.15.3. The contention period according to exemplary embodiments of the present invention separately arranges the period for the control frame with respect to highly important specific functions. That is, conventionally, the contention period is where a channel is acquired through contention among the frames regardless of a time-division method. However, the contention period according to an exemplary embodiment of the present invention is time-divided in accordance with a specific function.

FIG. 8 illustrates a configuration of a superframe 80 according to a first exemplary embodiment of the present invention.

Referring to FIG. 8, a “B” period 81 denotes a period that transmits a beacon frame, a “BWP” period 83 denotes a data-slot reservation period for a request for the data slot and a response thereto, and a “CP” period 82 denotes a control/asynchronous data period used to transmit a control frame and the asynchronous data frame that have nothing to do with the data slot reservation. The “BWP” 83 period and “CP” 82 period are in contention.

The request for the data slot and the response thereto must be made in order to reserve the data slot that transmits the uncompressed AV data, and thus, are separated from other control frames or the asynchronous data frame period.

Despite the separating period, the slot reservation may be made in the “CP” period 82 through contention with other control frames, in addition to the “BWP” period 83.

A “CFP” period 84 is a non-contention period, and is composed of a plurality of data slots, each of which is used to transmit uncompressed AV data.

Information on the “BWP” period 83 is in the form of an Information Element, and may be included in a beacon frame with other Information Elements, and may be transmitted to each device. The beacon frame is transmitted in a “B” period 81.

FIG. 9 illustrates a configuration of an Information Element containing information on a “BWP” period 83 according to an exemplary embodiment of the present invention.

Referring to FIG. 9, the Information Element 90 includes an element-identification information field 91, a length field 92, a “BWP Frequency” field 93, a “BWP FreqCount” field 94, a “BWP Location” field 95, and a “BWP Duration” field 96.

All Information Elements included in a beacon frame has identification information such as an ID, which is recorded in the element-identification information 91. Therefore, a device that has received the beacon frame can recognize corresponding information as the Information Element having information on a “BWP” period 83 by the element identification information.

The length filed 92 records the sum of the fields 93, 94, 95, and 96 in bytes.

The “BWP Frequency” field 93 may record “Always” or “Intermittent”. If a value corresponding to “Always” is recorded, the “BWP” period 83 exists in all superframes but if a value corresponding to “Intermittent” is recorded, the “BWP” period 83 intermittently exists in the superframes. That is, the “BWP Frequency” field 93 is information indicating the frequency of the “BWP” period 83 in the superframe.

A value corresponding to 1 or more may exist in the “BWP FreqCount” field 94. For example, if the “BWP Frequency” field 93 is set to a value corresponding to “Always”, the “FreqCount” field 94 is set to “1”. FIG. 10 illustrates a configuration of superframes where a “BWP Frequency” field 93 is set to “Always” and a “BWP FreqCount” field 94 is set to “1”. Referring to FIG. 10, all the superframes have “BWP” periods 101, 102, and 103.

Conversely, FIG. 11 illustrates a configuration of superframes when a “BWP Frequency” field 93 is set to “Intermittent” and a “BWP FreqCount” field 94 is set to “½”. Referring to FIG. 11, “BWP” periods 111 and 112 exist in every other superframe. That is, when the “BWP Frequency” field 93 is set to “Intermittent” and the “BWP FreqCount” field 94 is set to “1/n” (where n is a natural number), the “BMP” period exists per N superframes.

A “BWP Location” field 95 denotes an initial location where a “BWP” period starts. For example, the initial location can be traced when offset information is recorded from the point at which a device has received a beacon frame. The offset information may be recorded in units of microseconds (μs). A “BWP Duration” field 96 denotes the length of a “BWP” period 83.

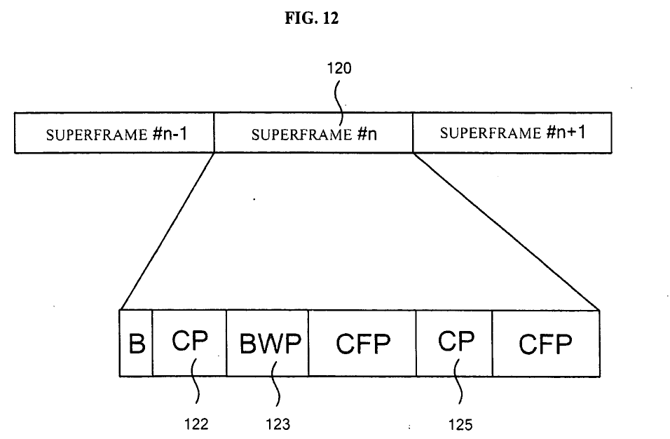

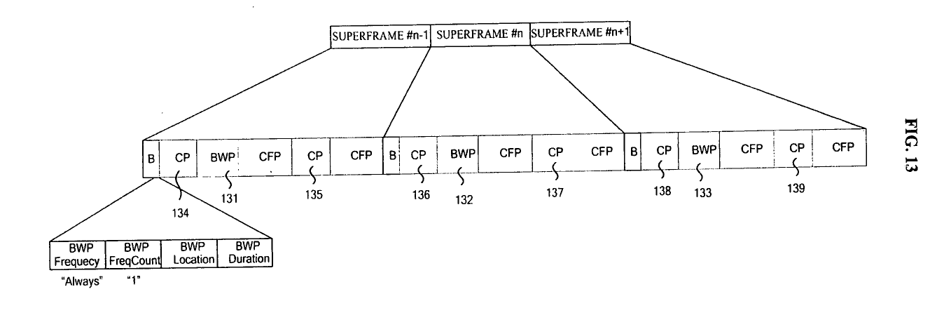

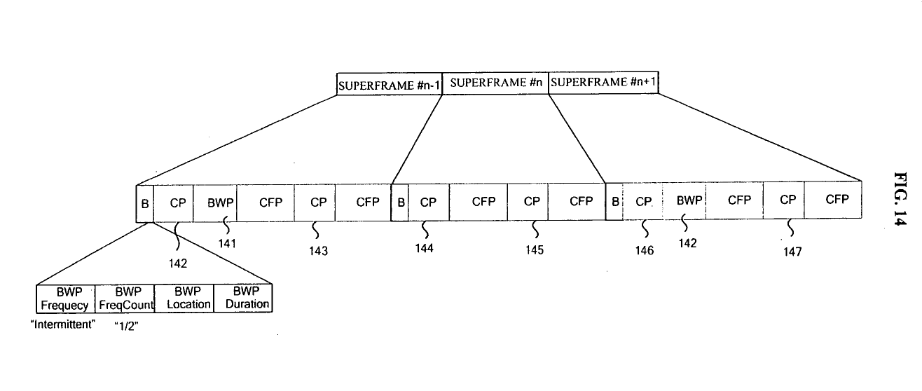

FIG. 12 illustrates a configuration of a superframe 120 according to a second exemplary embodiment of the present invention. Unlike the superframe of FIG. 8, the superframe 120 has a “BWP” period 123 and two or more “CP” periods 122 and 125. For example, if there is only one “CP” period in the superframe, a frame for data slot allocation is not transmitted thereto; the frame cannot be transmitted until the next superframe, causing a time delay during uncompressed AV data transmission. However, if there are two or more “CP” periods 122 and 125, such a delay can be minimized.

FIG. 13 illustrates a configuration of a superframe (if it is the same as that of the superframe 120 of FIG. 12) where the “BWP Frequency” 93 field is set to “Always” and the “BWP FreqCount” 94 field is set to 1 in the Information Element 90 of FIG. 9. Referring to FIG. 13, Superframes N−1, N, and N+1 respectively have “BWP” periods 131, 132, and 133 and “CP” periods 134 and 135, 136 and 137, and 138 and 139.

Conversely, FIG. 14 illustrates a configuration of a superframe (if it is the same as that of the superframe 120 of FIG. 12) where the “BWP Frequency” field 93 and the “BWP FreqCount” field 94 in the Information Element of FIG. 9 are respectively set to “Intermittent” and “½”.

Referring to FIG. 14, a “BWP” period does not exist in all superframes, i.e., “BWP” periods 141 and 142 exist in every other superframe. Superframes N−1, N, and N+1 respectively have “CP” periods 142 and 143, 144 and 145, and 146 and 147.

In addition, information on the “CP” period is created in the form of an Information Element, and may be included in a beacon frame with other Information Elements, and be transmitted to each device. Here, the created Information Element may have the same configuration as the Information Element of FIG. 9 and further include information on the number of “CP” periods in each superframe.

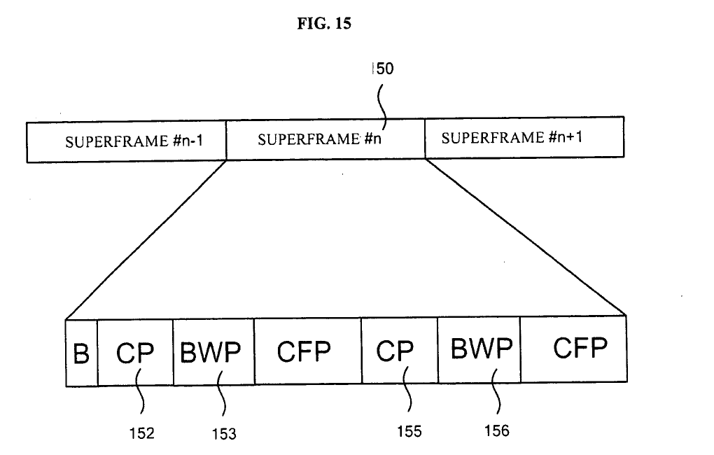

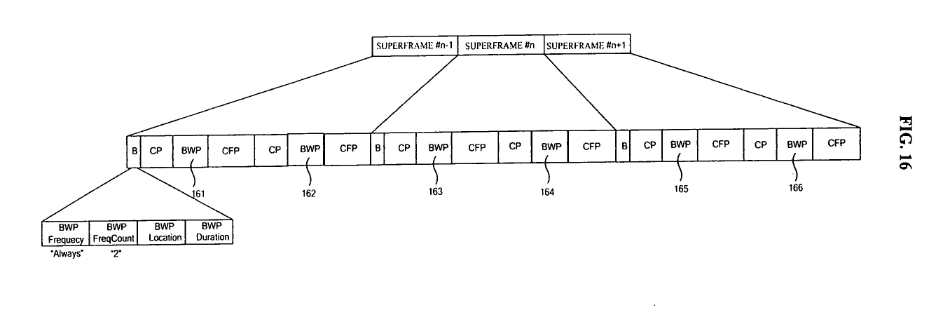

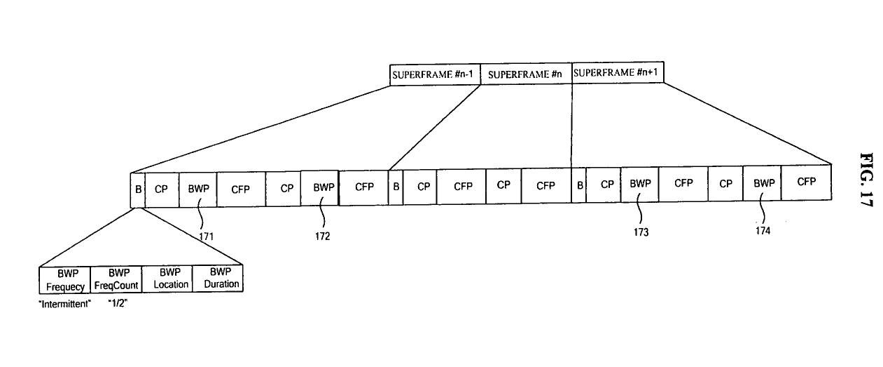

FIG. 15 illustrates a configuration of a superframe according to a third exemplary embodiment of the present invention. A superframe 150 has “CP” periods 152 unlike the superframe of FIG. 12, and 153 and each “CP” period has “BWP” periods 153 and 156.

FIG. 16 illustrates a configuration of a superframe (it is the same as that of the superframe 150 of FIG. 15) where the “BWP Frequency” field 93 and the “BWP FreqCount” field 94 in the Information Element of FIG. 9 are respectively set to “Always” and “2”.

Conversely, FIG. 17 illustrates a configuration of a superframe (it is the same as that of the superframe 150 of FIG. 15) where the “BWP Frequency” field 93 and the “BWP FreqCount” field 94 in the Information Element of FIG. 9 are respectively set to “Intermittent” and “½”. Referring to FIG. 17, “BWP” periods 171 and 172, and 173 and 174 exist in every other superframe.

In addition, information on a “CP” period is in the form of an Information Element, and may be included in a beacon frame with other Information Elements, and transmitted to devices.

Information on the “BWP” period included in the beacon frame may be flexibly managed depending on the condition. For example, if a data slot request is not frequently made, it is ineffective to separately have the “BWP” period. Therefore, a network coordinator may manage the “BWP” period intermittently. If the “BWP” period does not exist in the superframe, the request for the data slot and a response thereto can be executed.

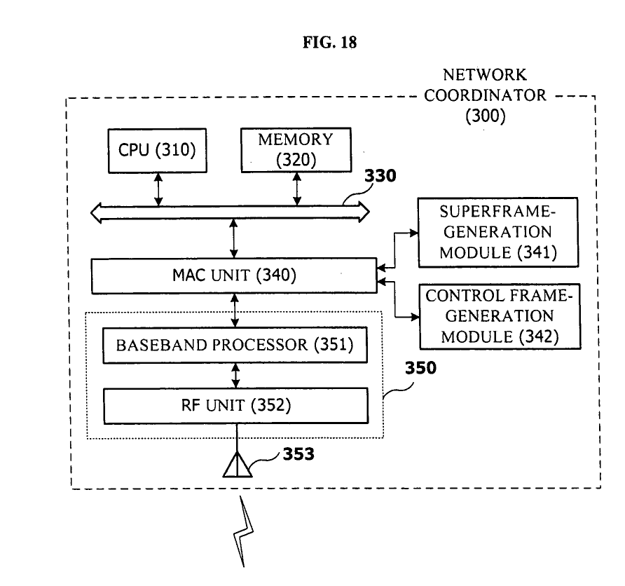

FIG. 18 is a block diagram illustrating a configuration of a network coordinator 300 according to an exemplary embodiment of the present invention.

The network coordinator 300 may include a CPU 310, a memory 320, a MAC unit 340, a PHY unit 350, a superframe-generation module 341, a control frame-generation module 342, and an antenna 353.

The CPU 310 controls other components connected to a bus 330, and is in charge of a process in an upper layer of a MAC layer. That is, the CPU 310 processes a received MAC service data unit (MSDU) from the MAC unit or generates a transmitted MSDU and provides it to the MAC unit 340.

The memory 320 stores the processed received MSDU or the generated transmitted MSDU temporarily. The memory may be implemented in a volatile memory such as a read-only memory (ROM), a programmable read-only memory (PROM), an erasable programmable read-only memory (EPROM), an electronically erasable programmable read-only memory (EEPROM), and a flash memory, or a non-volatile memory such as a random-access memory (RAM), or a storage media such as a hard disk and an optical disk, or other forms well known in the related art.

The media access control (MAC) unit 340 appends a MAC header to the MSDU provided from the CPU 310, i.e., multimedia data-to-be-transmitted, and generates a MAC protocol data unit (MPDU). The MAC unit 340 then transmits the MPDU to the PHY unit 350, and erases the MAC header from the MPDU transmitted via the PHY unit 350.

As described above, the MPDU transmitted by the MAC unit 340 includes a superframe that is transmitted during a beacon period. The MPDU transmitted by the MAC unit 340 includes an association-request frame, a data-slot-request frame, and a variety of control frames.

The superframe-generation module 341 generates one of the superframes described above, and provides it to the MAC unit 340 and the control frame-generation module 342 generates the association-request frame, the data-slot-request frame, and other control frames and provide these to the MAC unit.

The PHY unit 350 appends a signal field or a preamble to the MPDU provided by the MAC unit 340, and generates a PPDU. The generated PPDU, i.e., the data frame, is converted into a signal, and transmitted through the antenna. The PHY unit 350 may be further divided into a baseband processor 351 that processes a baseband signal, and a radio frequency (RF) unit that generates a radio signal from the baseband signal, and transmits it via an antenna 353.

Particularly, the baseband processor 351 formats the frames and codes the channels and the RF unit 352 amplifies analog signals, converts digital signals into analog signals or vice versa, and modulates the signals.

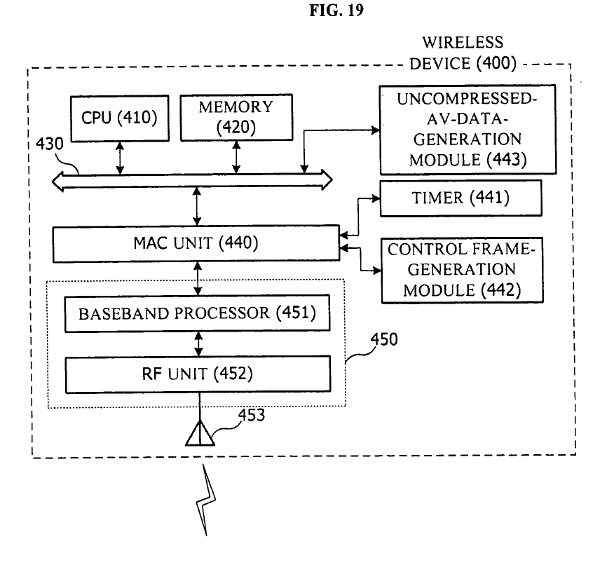

FIG. 19 illustrates a configuration of a wireless device 400 according to an exemplary embodiment of the present invention. A MAC unit 440, a memory 420, and a PHY unit 450 in the wireless device 400 have the same basic functions as those in the network coordinator 300.

A timer 441 checks the time when a contention or a non-contention period included in a superframe starts and ends. A control frame-generation unit 442 generates an association-request frame and a data-slot-request frame, and provides them to a MAC unit 440.

An uncompressed-AV-data-generation module 443 generates and stores uncompressed AV data. For example, the uncompressed-AV-data-generation module 443 records video data composed of RGB values.

The MAC unit 440 generates MPDU by appending a MAC header to the uncompressed AV data or the control frame, and transmits the MPDU via a PHY unit 450.

The term “module” described with reference to FIG. 2A means, but is not limited to, a software or hardware component, such as a Field Programmable Gate Array (FPGA) or an Application Specific Integrated Circuit (ASIC), which executes certain tasks. A module may advantageously be configured to reside in the addressable storage medium, and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As described above, according to exemplary embodiments of the present invention, AV data can be efficiently transmitted through mmWave (in tens of GHz).

The exemplary embodiments of the present invention have been explained with reference to the accompanying drawings, but it will be apparent to those skilled in the art that various modifications and changes may be made thereto without departing from the scope and spirit of the invention. Therefore, it should be understood that the above exemplary embodiments are not restrictive but illustrative in all aspects.

What is claimed is:

1. A method of allocating a data slot to transmit uncompressed audiovisual (AV) data, the method comprising:
transmitting a first superframe that includes a data-slot-reservation period during a first beacon period and information thereon;
receiving a frame that requests the data slot from at least one of wireless devices included in a network in a data-slot-request period;
transmitting a response frame to the data-slot-request frame, to said at least one of the wireless devices; and
transmitting a second superframe that includes a data slot allocated to said at least one of the wireless devices during a second beacon period.

2. The method of claim 1, wherein telecommunications with the at least one of the wireless devices are executed via a mmWave channel.

3. The method of claim 1, wherein the first and second superframes comprise a contention period and a non-contention period, the contention period including a control frame, a period for transmitting and receiving asynchronous data and the data-slot-reservation period, and the non-contention period including one or more allocated data slots.

4. The method of claim 3, wherein the data-slot-reservation period is arranged adjacent to the control frame and the frame for transmitting and receiving asynchronous data.

5. The method of claim 1, wherein the information on the data-slot-reservation period comprises information on a frequency of the data-slot-reservation period in a superframe.

6. The method of claim 1, wherein information on a position of the data-slot-reservation period is included in a superframe.

7. The method of claim 1, wherein information on a length of the data-slot-reservation period is included in a superframe.

8. A method of transmitting uncompressed audiovisual (AV) data, the method comprising:
receiving a first superframe that includes a data-slot-reservation period and information thereon from a network coordinator during a first beacon period;
transmitting a frame that requests a data slot to the network coordinator, in the data-slot-reservation period;
receiving a second superframe that includes the data slot allocated by the network coordinator during a second beacon period; and
transmitting uncompressed AV data to other devices in the allocated data slot period.

9. The method of claim 8, wherein the transmitting of the frame comprises receiving a response frame with respect to the request frame in the data-slot-reservation slot, from the network coordinator.

10. The method of 8, wherein telecommunications with the other devices are executed via a mmWave channel.

11. The method of claim 8, wherein the first and second superframes comprise a contention period and a non-contention period, the contention period including a control frame, a period for transmitting and receiving asynchronous data and the data-slot-reservation period, and the non-contention period including one or more allocated data slots.

12. The method of claim 11, wherein the data-slot-reservation period is arranged adjacent to the control frame and a frame corresponding to the period for transmitting and receiving asynchronous data.

13. The method of claim 8, wherein information on the data-slot-reservation period comprises information on a frequency of the data-slot-reservation period in a superframe.

14. The method of claim 11, wherein information on a position of the data-slot-reservation period is included in a superframe.

15. The method of claim 11, wherein information on a length of the data-slot-reservation period is included in a superframe.

16. An apparatus for allocating a data slot for uncompressed audiovisual (AV) data, the apparatus comprising:
a first unit which transmits a first superframe including a data-slot-reservation period during a first beacon period and information thereon;
a second unit which receives a frame that requests the data slot from at least one wireless device included in a network in the data-slot-request period;
a third unit which transmits a frame in response to the data-slot-request frame to at least one of the wireless devices; and
a fourth unit which transmits a second superframe including a data slot allocated to said at least one of the wireless devices during a second beacon period.

17. The apparatus of claim 16, wherein telecommunications with the at least one of the wireless devices are executed via a mmWave channel.

18. The apparatus of claim 16, wherein the first and second superframes comprise a contention period and a non-contention period, the contention period including a control frame, a period for transmitting and receiving asynchronous data and the data-slot-reservation period, and the non-contention period including one or more allocated data slots.

19. The apparatus of claim 18, wherein the data-slot-reservation period is arranged adjacent to the control frame and a frame corresponding to the period for transmitting and receiving asynchronous data.

20. The apparatus of claim 16, wherein information on the data-slot-reservation period comprises information on a frequency of the data-slot-reservation period in a superframe.

21. The apparatus of claim 16, wherein information on a position of the data-slot-reservation period is included in a superframe.

22. The apparatus of claim 16, wherein information on a length of the data-slot-reservation period is included in a superframe.

23. An apparatus for transmitting uncompressed audiovisual (AV) data, the apparatus comprising:
a first unit which receives a first superframe including a data-slot-reservation period and information thereon from a network coordinator during a first beacon period;
a second unit which transmits a frame that requests a data slot from the network coordinator, in the data-slot-reservation period;
a third unit which receives a second superframe including the data slot allocated by the network coordinator during a second beacon period; and
a fourth unit which transmits uncompressed AV data to other devices in the allocated data slot period.

24. The apparatus of claim 23, wherein telecommunications with the network coordinator are executed via a mmWave channel.

25. The apparatus of claim 23, wherein the first and second superframes comprise a contention period and a non-contention period, the contention period including a control frame, a period for transmitting and receiving asynchronous data and the data-slot-reservation period, and the non-contention period including one or more allocated data slots.

26. The apparatus of claim 25, wherein the data-slot-reservation period is arranged adjacent to the control frame and a frame corresponding to the period for transmitting and receiving asynchronous data.

27. The apparatus of claim 23, wherein information on the data-slot-reservation period comprises information on a frequency of the data-slot-reservation period in a superframe.

28. The apparatus of claim 23, wherein information on a position of the data-slot-reservation period is included in a superframe.

29. The apparatus of claim 23, wherein information on a length of the data-slot-reservation period is included in a superframe.

30. A data structure for transmitting and receiving A/V data via a network, the structure comprising:
a beacon period wherein a beacon is transmitted, the beacon containing information on the frequency of a data-slot-reservation period for the A/V data transmission;
a contention period wherein a control frame is transmitted, the control frame controlling the operations of wireless devices through a contention thereamong in the network; and
a non-contention period consisting of one or more of data slots for transmitting and receiving the AV data among the wireless devices.
